(19) United States
(12) Patent Application Publication
(10) Pub. No.: US 2015/0272388 A1
(43) Pub. Date: Oct. 1, 2015

(54) CHIMNEY STARTER AND AN IGNITE UNIT

(71) Applicant: STENBERG A/S, Norre Nebel (DK)

(72) Inventor: Soren Jorgensen, Hjerm (DK)

(73) Assignee: STENBERG A/S, Norre Nebel (DK)

(21) Appl. No.: 14/434,298

(22) PCT Filed: Sep. 11, 2013
(86) PCT No.: PCT/DK2013/050292

§ 371 Date: Apr. 8, 2015

(30) Foreign Application Priority Data
Oct. 11, 2012 (DK) PA 2012 70620

(51) Int. Cl. A47J 37/07; F23Q 7/04

(52) U.S. Cl. CPC A47J 37/079; F23Q 7/04

(57) ABSTRACT

A chimney starter having a tubular housing including a charcoal chamber extending between the upper opening of the tubular housing and thermal insulation means, blowing means arranged on the opposite side of the thermal insulation means in relation to the charcoal chamber, and at least one duct extending through the thermal insulation means from the blowing means to the charcoal chamber and heating means arranged in the at least one duct.

### TECHNICAL FIELD

The invention relates to a chimney starter comprising a tubular housing for igniting charcoal to be used in a grill and an ignite unit for igniting solid fuel—such as charcoal—arranged in a tubular housing placed on top of the ignite unit.

### BACKGROUND

A chimney starter is used by placing charcoal (as lump charcoal or briquettes) in a chimney shaped device so that they stack on top of a grate arranged inside the chimney. Newspaper is then placed underneath the grate inside the chimney and set on fire. This fire then rises through the grate and sets the charcoal alight. Once the charcoal is all burning, the lit charcoal is dumped into the grill.

But it can be difficult to set the newspaper on fire and often additional newspaper will have to be lit beneath the charcoal to light the charcoal. Furthermore, it takes relatively long time to light the charcoal efficiently in this manner.

Thus, from U.S. Pat. No. 3,060,868 it is therefore known to replace the grate by an electrical heating element and then establish an air flow up through the charcoal by means of an electrical air blower arranged to blow air into the chimney beneath the heating element. But this chimney starter design is both complex and expensive.

And from U.S. Pat. No. 5,507,274 it is known to form a charcoal lighter apparatus with a lower gas-bottle-storage region separated from an upper charcoal-briquette-storage region by means of a barrier allowing heat transfer from the lower gas-bottle-storage region to the upper charcoal-briquette-storage region. But a gas bottle present an explosion risk and makes the charcoal lighter apparatus heavy.

### BRIEF SUMMARY

The invention provides for a chimney starter comprising a tubular housing including a charcoal chamber extending between the upper opening of the tubular housing and thermal insulation means. The chimney starter further comprises blowing means arranged on the opposite side of the thermal insulation means in relation to the charcoal chamber, at least one duct extending through the thermal insulation means from the blowing means to the charcoal chamber and heating means arranged in the at least one duct.

Arranging the charcoal chamber and the blowing means on either side of the thermal insulation means is advantageous in that the blowing means hereby is protected from the heat radiation from the burning charcoal. And arranging the thermal insulation means at the bottom of the tubular housing is advantageous in that it enables that the blowing means can be arranged underneath the charcoal chamber hereby providing a more symmetrical chimney starter design with a more a symmetrical weight distribution hereby reducing the risk of the chimney starter being toppled.

It should be noted that by the term “thermal insulation means” is to be understood any means capable of significantly lowering thermal conductivity from the charcoal chamber to the opposite side of the thermal insulation means. Such thermal insulation means include any kind of material having a low thermal conductivity i.e. typically below 0.5 watts per meter kelvin (W·m−1·K−1) such as mineral wool or foam, ceramic insulation tiles, glass foam or other.

It should also be noted that by the term “blowing means” is to be understood any means capable of creating an air flow such as any type of axial-flow fan, centrifugal fan, cross-flow fan, bellows or similar.

It should also be noted that by the term “heating means” is to be understood any kind of heater or heating element capable of heating the passing air flow enough to reach the auto-ignition temperature of the charcoal—which typically is around 245° Celsius—such as any type of means comprising resistance wires, high-powered incandescent heat lamps, PTC ceramics, refractory ceramics or other.

In an aspect of the invention, said chimney starter further comprises grate means arranged inside said tubular housing between said upper opening of said tubular housing and said thermal insulation means.

Arranging grate means inside the tubular housing above the thermal insulation means is advantageous in that once the charcoal starts burning it generates much heat, which potentially could damage the thermal insulation means if the charcoal is in direct contact with the thermal insulation means. Furthermore, grate means also enables proper air supply over substantially the entire bottom surface of the charcoal to feed the combustion efficiently and thereby increase the efficiency of the chimney starter.

It should also be noted that by the term “grate means” is to be understood any kind of perforated plate, rod mesh, frame of bars or other type of grate—typically formed by metal such as steel or stainless steel—enabling that charcoal can be placed on the grate means which comprises openings through which air may flow to feed the combustion of the charcoal.

In an aspect of the invention, one or more vent holes are formed through said tubular housing between said grate means and said thermal insulation means.

Arranging vent holes in the sides of the tubular housing is advantageous in that the holes enables air supply to the charcoal combustion even when the blowing means is turned off, hereby increasing the efficiency of the chimney starter. And arranging the holes between the grate means and the thermal insulation means is advantageous in that the air can then be supplied where the charcoal are ignited i.e. at the bottom and in that the risk of hot charcoal falling out of the holes is reduced.

In an aspect of the invention, said tubular housing extends past said thermal insulation means to form a blower housing substantially enclosing said blowing means.

Making the tubular housing extend all the way down to form a blower housing substantially encircling the blowing means is advantageous in that it provides for a simple and inexpensive cover of the blower means protecting the blower means from the environment (rain, leafs etc.) and protecting the user from getting in contact with the blower means during use.

In an aspect of the invention, said thermal insulation means is arranged inside said tubular housing.

Arranging the thermal insulation means inside the tubular housing is advantageous in that it enables that one continuous tubular housing can form both the charcoal chamber and the blower housing.

In an aspect of the invention, said blowing means is arranged to establish an air flow through said at least one duct, past said heating means and into said charcoal chamber.

Hereby is achieved an advantageous embodiment of the invention.

In an aspect of the invention, said thermal insulation means comprises mineral wool.

Mineral wool made of materials such as fiberglass, ceramic fibers or stone wool has a very low thermal conductivity i.e. typically below 0.1 watts per meter kelvin (W·m−1·K−1) and since mineral wool is a very durable, imperishable and heat resistant material it is particularly suited as thermal insulation means in a chimney starter.

In an aspect of the invention, said chimney starter further comprises a timer arranged to turn off said blowing means and/or said heating means.

Providing the chimney starter with a timer comprising means—such as a switch—to turn off the blowing means and/or the heating means after a predetermined time is advantageous in that the timer can hereby ensure that the charcoal is not over-ignited.

In an aspect of the invention, said heating means is electrical heating means having a power of between 200 W and 4000 W, preferably between 500 W and 3000 W and most preferred between 1000 W and 2000 W.

If the power of the heating means is too high they become too expensive and difficult to fit inside the duct. However, it the power is too little it will take too long to ignite the charcoal. Thus, the present power ranges presents an advantageous relationship between cost and efficiency.

In an aspect of the invention, said blowing means is centrally arranged in relation to said tubular housing.

Arranging the blowing means centrally in the tubular housing is advantageous in that the blowing means is thereby well protected beneath the thermal insulation means and in that it provides for an advantageous weight distribution of the chimney starter.

In an aspect of the invention, said at least one duct including said heating means is centrally arranged in relation to said tubular housing.

Arranging the duct and the heating means centrally in the tubular housing is advantageous in that the hot air flow from the duct hereby will ignite the charcoal centrally allowing the fire to spread to all sides and thereby ensure an efficient ignition. Furthermore, the centrally placement of the duct and heating means provides for an advantageous weight distribution of the chimney starter.

In an aspect of the invention, said a tubular housing is formed separate from said blowing means and said heating means.

Forming the tubular housing as a separate part is advantageous in that only the tubular housing—holding the charcoal—will have to be moved around when the charcoal have been ignited. I.e. the potentially heavy ignite unit—comprising thermal insulation means, blowing means, heating means and blower housing—can remain relatively stationary—e.g. in close proximity of a power outlet to which the ignite unit is connected.

In an aspect of the invention, said thermal insulation means has a thickness between 8 mm and 300 mm, preferably between 15 mm and 200 mm and most preferred between 25 mm and 100 mm in the longitudinal direction of said tubular housing.

If the thermal insulation means are too thin the insulation will not be able to protect the blower means sufficiently and if the layer is too thick the cost is increased and the chimney starter becomes too high. The present thickness ranges therefore presents an advantageous relationship between efficiency and cost.

The invention also provides for an ignite unit for igniting solid fuel—such as charcoal—arranged in a tubular housing placed on top of the ignite unit. The ignite unit comprises a top surface including a support surface for holding a tubular housing being placed on the top surface and thermal insulation means arranged beneath at least a part of the top surface. The ignite unit also comprises blowing means arranged beneath the thermal insulation means and at least one duct extending through the thermal insulation means from the blowing means to or through the top surface, wherein heating means are arranged in the at least one duct.

It is advantageous to provide a ignite unit comprising thermal insulation means, blowing means, heating means and blower housing with a top surface including a support surface so that a tubular housing can be placed on top of the ignite unit during ignition of the content in the tubular housing. Furthermore it is advantageous to arrange the ignite unit so that the blowing means is separated from the tubular housing in that the blowing means hereby is protected from potentially damaging heat radiation from the ignited fuel in the tubular housing.

### BRIEF DESCRIPTION OF THE FIGURES

The invention will be described in the following with reference to the figures in which

FIG. 1 illustrates a cross section through the middle of a chimney starter according to a first embodiment of the invention, as seen from the side,

FIG. 2 illustrates the chimney starter shown in FIG. 1, as seen from the top,

FIG. 3 illustrates a cross section through the middle of a chimney starter according to a second embodiment of the invention, as seen from the side, and

FIG. 4 illustrates a cross section through the middle of a two-piece chimney starter, as seen from the side.

### DETAILED DESCRIPTION

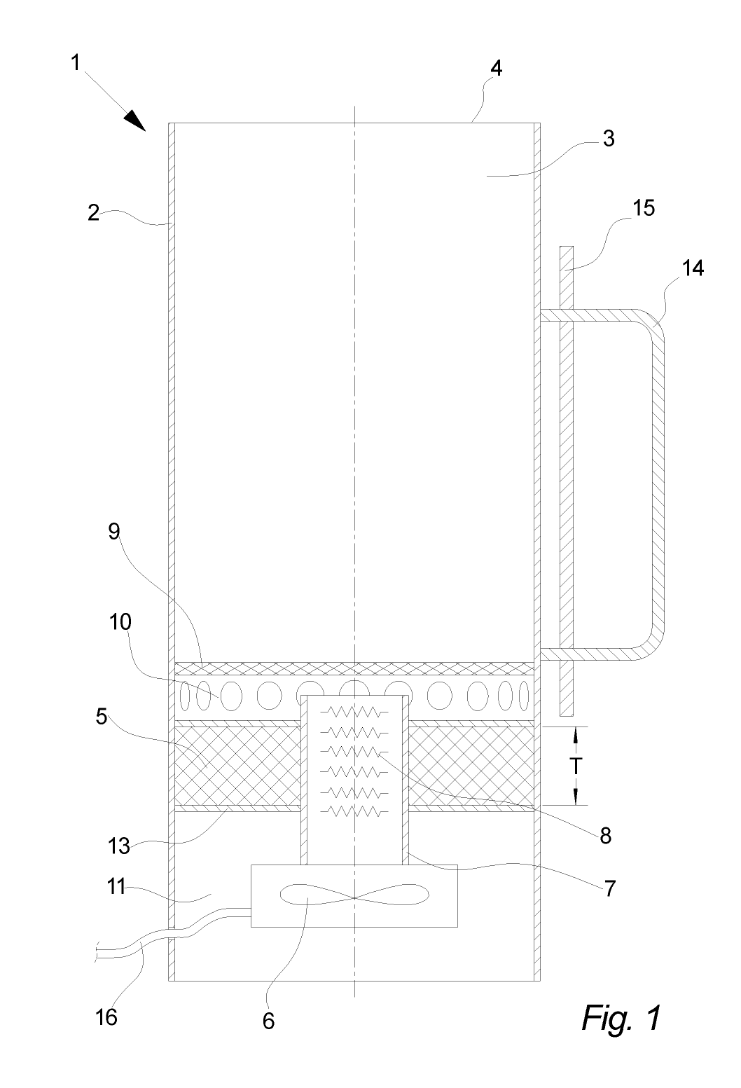

FIG. 1 illustrates a cross section through the middle of a chimney starter 1 according to a first embodiment of the invention, as seen from the side.

In this embodiment the chimney starter 1 comprises a tubular housing 2 extending all the way from the top to the bottom of the chimney starter 1. Inside the tubular housing 2 is arranged thermal insulation means 5 dividing the tubular housing 2 into a charcoal chamber 3 above the thermal insulation means 5 and a blower housing 11 below the thermal insulation means 5.

Thus, in this embodiment the charcoal chamber 3 extends from the upper opening 4 of the tubular housing 2—through which the charcoal enters and exits the chimney starter 1—and down to the thermal insulation means 5.

In this embodiment the thermal insulation means 5 is formed as of a layer of fiberglass insulation wool having a thickness T of 50 mm and placed between two plates 13 but in another embodiment the thermal insulation means 5 could be formed without the plates 13 and/or the low thermal conductivity could be provided by means of another “filling” as previously discussed. Furthermore, the thermal insulation means 5 could have another thickness such as around 10 mm, 25 mm, 40 mm, 60 mm, 75 mm or 100 mm.

On the side of the tubular housing 2 a handle 14 is provided to enable that the chimney starter 1 may be moved around even though the tubular housing 2 is burning hot from the burning charcoal inside the charcoal chamber 3. To protect the user from heat radiation, the handle 14 is in this embodiment provided with a heat shield 15. In another embodiment the handle 14 could further be provided with a grip made of a material having a lower thermal conductivity that steel i.e. it could be made from some sort of ceramic, plastic, rubber, wood or another relatively heat resistant material suited for forming a grip for a chimney starter 1.

In this embodiment the charcoal chamber 3 is provided with grate means 9 in the form of a perforated flat plate arranged approximately 30 mm over the thermal insulation means 5 to ensure that the hot charcoal is not in direct contact with the thermal insulation means 5.

However, in another embodiment the grate means 9 could be placed and formed different i.e. the grate means 9 could be placed closer to the thermal insulation means 5 in a distance of e.g. approximately 10 mm or 20 mm or the grate means 9 could be placed further away from the thermal insulation means 5 in a distance of e.g. approximately 40 mm, 50 mm or 60 mm.

In another embodiment the charcoal chamber 3 could be formed completely without grate means 9 or the grate means 9 would only extend over the opening of the duct 7—which will be discussed in the following. Or the grate means could be formed other than flat i.e. the grate means 9 could arch downwards or upwards towards the center or it could be corrugated to increase the contact surface.

The placement of the grate means 9 enables that an array of vent holes 10 can be arranged in the sides of the tubular housing 2 between the grate means 9 and the thermal insulation means 5 to ensure sufficient air supply to the combustion process.

In this embodiment the vent holes 10 has a diameter of 20 mm but in another embodiment they could be bigger or smaller such as approximately 10 mm, 15 mm, 25 mm, 30 mm or 40 mm.

In another embodiment the tubular housing 2 could be provided with further vent holes 10 e.g. arranged above the grate means 9 or in the sides of the blower housing 11.

In this embodiment a duct 7 is provided down through the middle of the thermal insulation means 5 to enable an air flow from the blowing means 6 arranged bellow the thermal insulation means 5 and up to the charcoal chamber 3 above the thermal insulation means 5. In another embodiment the thermal insulation means 5 could comprise several ducts 7 such as four, six, eight or twelve and the ducts 7 could be placed differently trough the thermal insulation means 5.

In this embodiment the duct 7 extends through the thermal insulation means 5 and a little into the charcoal chamber 3 so that it stops approximately 10 mm under the grate means 9.

However, in another embodiment the upper end of the duct 7 could be arranged flush with the upper surface of the thermal insulation means 5 or the upper end of the duct 7 could be arranged closer or further away from the grate means 9.

In this embodiment electrical heating means 8 are arranged inside the duct 7 to heat the passing air flow to a temperature above the ignition temperature of the material to be ignited in the charcoal chamber 3. In this embodiment the heating means 8 are formed by a number of resistance wires but in another embodiment the heating means 8 could be any other type of heating means 8 known from hair dryers, heat guns, soldering guns or any other devices capable of heating a passing air flow significantly.

At the bottom, the duct 7 is connected to blowing means 6 which in this case is an electrical fan. When the blowing means 6 is turned on it establishes an air flow from outside the charcoal chamber 3, up through the duct 7, past the heating means and up into the charcoal chamber 3 where the now heated air flow will heat and ignite the charcoal while the generated air flow at the same time will feed an established combustion of the charcoal.

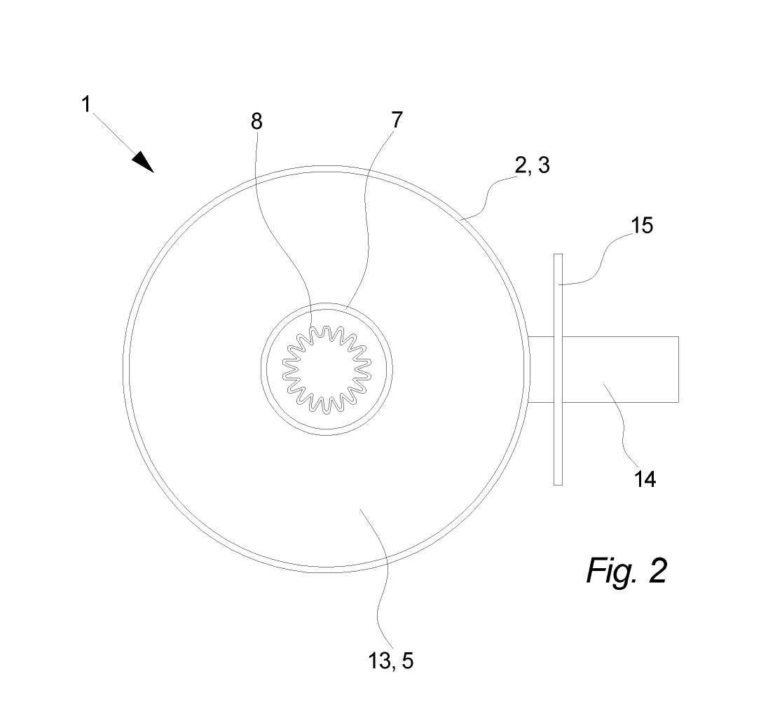

FIG. 2 illustrates the chimney starter 1 shown in FIG. 1, as seen from the top.

In this embodiment the chimney starter 1 is shown without grate means 9.

In this embodiment the tubular housing 2 is formed as a circular pipe with a constant inner diameter of approximately 220 mm.

However, in another embodiment the diameter could be smaller or bigger such as approximately 160 mm, 200 mm, 250 mm, 280 mm or 300 mm. However, the diameter should preferably not be less than 150 mm in that the charcoal will then be heated too much.

In another embodiment the cross section of the tubular housing 2 could be other than circular—such as polygonal, square, rectangular or some more or less complex shape—and/or the cross section could vary along the longitudinal extent of the tubular housing 2 either in shape and/or in diameter or width

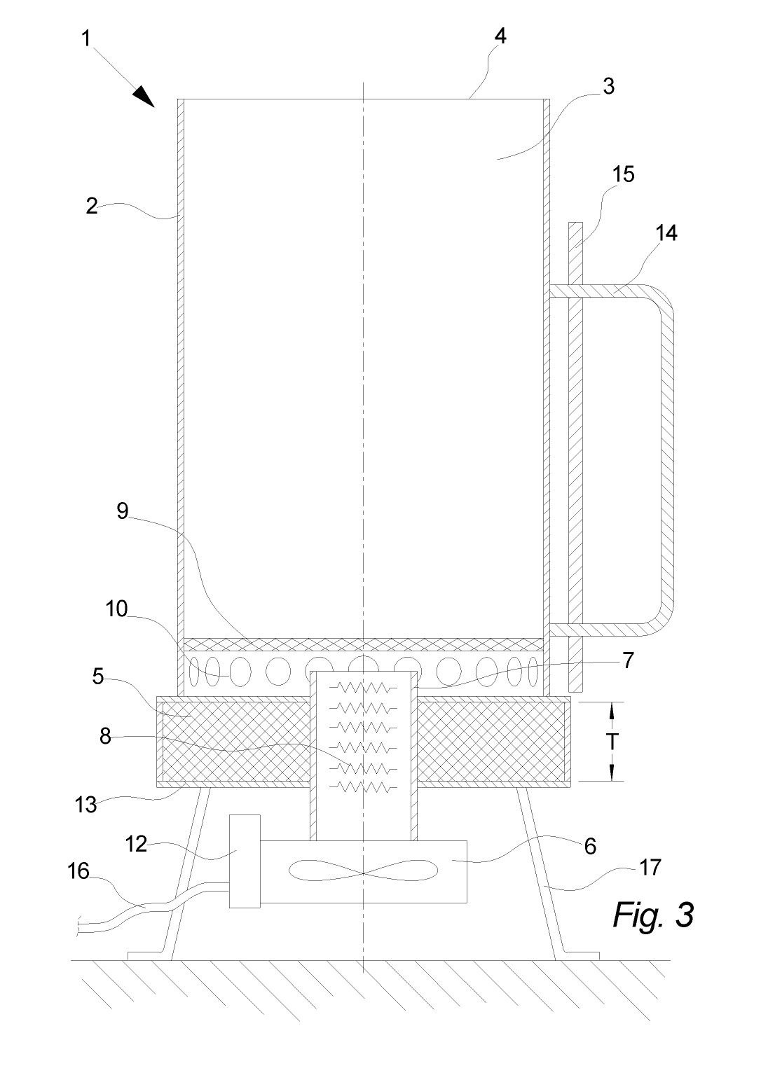

FIG. 3 illustrates a cross section through the middle of a chimney starter 1 according to a second embodiment of the invention, as seen from the side.

In this embodiment the tubular housing 2 only extends from the upper opening 4 and down to the thermal insulation means 5. Thus, in this embodiment the tubular housing 2 does not encircle the blowing means 6 to form a blower housing 11.

To distance the blowing means 6 from the underlying surface the chimney starter 1 is in this embodiment provided with a number of legs 17.

In another embodiment a dedicated and separate blower housing 11 could be provided around the blowing means 6 on the underside of the thermal insulation means 5.

In this embodiment the chimney starter 1 is provided with a timer 12 capable of turning off the blowing means 6 and/or the heating means 8 after a preset period of time. This predefined period of time could either be provided to the timer 12 each time as an input from a user or it could be a permanently defined time ensuring that the blowing means 6 and the heating means 8 never runs more that this preset time e.g. to ensure that the charcoal never gets over-heated.

The timer 12 could also turn off the heating means 8 after a predefined time—i.e. after a period of time where the charcoal almost always will be ignited—and then continue running the blowing means 6 for a longer preset period of time to feed the combustion and speed up the process of igniting all the charcoal while at the same time significantly reducing the power consumption of the chimney starter 1 in that the heating means is turned off. In such an embodiment or in an embodiment without a timer the blowing means 6 could also be two-speed of even multiple-speed to better control the air supply and thereby better ensure that the charcoal is not over-heated.

In this embodiment both the heating means 8 and the blowing means 6 are electrically powered so in this embodiment the chimney starter 1 is provided with a cord 16 which in the end is provided with a plug (not shown) for plugging the chimney starter 1 to a standard power outlet such as a standard 220 V/110 V wall socket.

However, in another embodiment the chimney starter 1 could be battery powered or it could comprise other internal power sources such as a fuel cell.

In this embodiment the cord 16 comprises a fire resistant outer coating of silicone to ensure that hot coals falling out of the chimney starter 1 and landing on the cord 16 does not damage the cord 16. In another embodiment this effect could also be achieved by making at least the first part of the cord 16 extend through a metal pipe protecting the cord 16.

In this embodiment the tubular housing 2, the plates 13, the legs 17, the handle 14 and the heat shield 15 are all formed by stainless steel but in another embodiment one or more of these components could be formed in another material such as steel, cast iron, aluminum, ceramic or another heat resistant material.

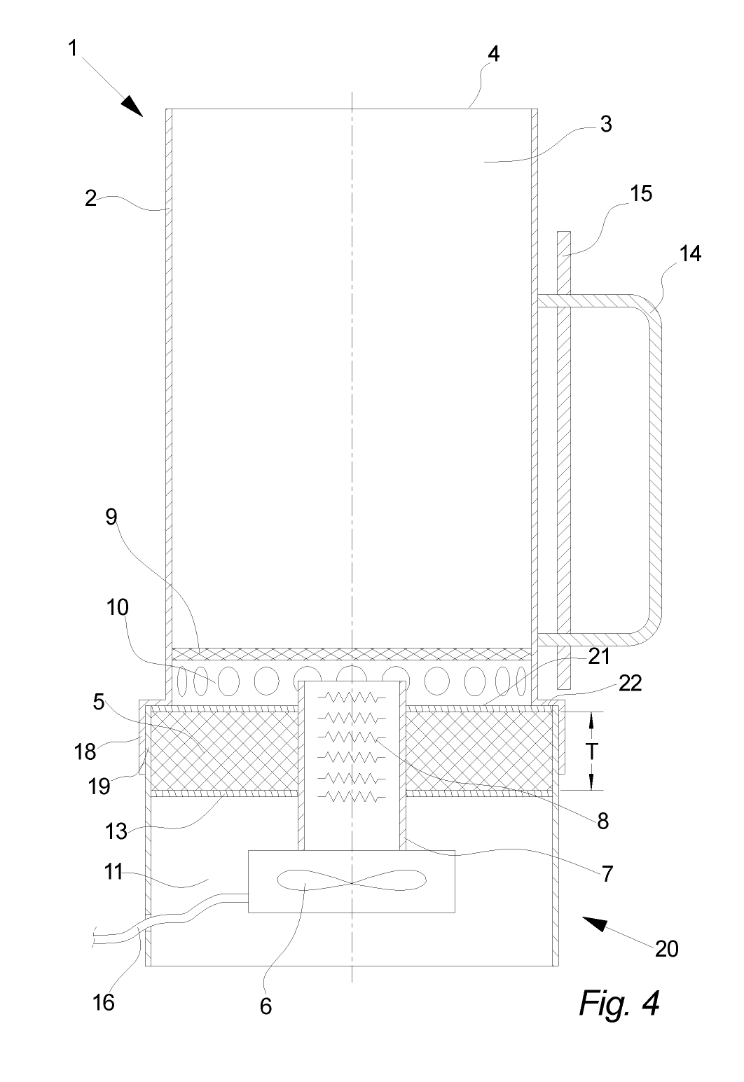

FIG. 4 illustrates a cross section through the middle of a two-piece chimney starter 1, as seen from the side.

In this embodiment the tubular housing 2 is formed separate from and placed on top of an ignite unit 20, i.e. in this embodiment the tubular housing 2 is formed separate from the blowing means 6 and the heating means 8.

In this embodiment the ignite unit 20 comprises a top surface 21 having a support surface 22 carrying the weight of the tubular housing 2 being placed on the top surface 21. The ignite unit 20 further comprises thermal insulation means 5, blowing means 6 and heating means 8 arranged inside a blower housing 11.

The two-piece chimney starter 1 design entails that when the charcoal in the tubular housing 2 have been ignited sufficiently by the heating means 8 and the blowing means 6 of the ignite unit 20, the tubular housing 2 can be lifted off of the ignite unit 20 so that only the tubular housing 2 and the ignited charcoal will have to be transported to the grill.

In this embodiment the tubular housing 2 is formed with a bottom protrusion 18 enabling that the tubular housing 2 can enclose a top part 19 of the blower housing 11 while being supported by the support surface 22 of the top surface 21. This design entails that the tubular housing 2 is always concentric with the ignite unit 20 when the two are put together.

In the embodiment shown in FIG. 3 the tubular housing 2 is welded to the top surface 21 of the ignite unit 20 but in another embodiment of the invention the tubular housing 2 could be formed separate from the ignite unit 20 disclosed in FIG. 3. Thus, if the tubular housing 2 is separate from the ignite unit, the tubular housing 2 is simply placed on the top surface 21 of the ignite unit 20, where after the heating means 8 and blowing means 6 are turned on to ignite the charcoal in the tubular housing 2.

If the tubular housing 2 is formed separate from the ignite unit 20, the tubular housing 2 could be a traditional grill starter. I.e. the ignite unit 20 would be offered for sale separately so that customers could use the ignite unit 20 to ignite charcoal in a traditional grill starter—i.e. a grill starter that previously was used traditionally by placing and igniting paper underneath the charcoal in the charcoal chamber so that the flames from the paper will ignite the charcoal.

It should be noted that all orientation references like: bottom, top, upper, lower, above, beneath, bellow etc. all refer to the normal orientation of the chimney starter 1 when it is used for starting a fire in charcoal placed in the charcoal chamber 3 i.e. when the longitudinal direction of the tubular housing 2 is arranged substantially vertically with the blowing means 6 at the bottom.

The invention has been exemplified above with reference to specific examples of tubular housings 1, thermal insulation means 5, blowing means 6 and other. However, it should be understood that the invention is not limited to the particular examples described above but may be designed and altered in a multitude of varieties within the scope of the invention as specified in the claims.

1. A chimney starter comprising:
a tubular housing including a charcoal chamber extending between an upper opening of said tubular housing and thermal insulation means,
blowing means arranged on an opposite side of said thermal insulation means in relation to said charcoal chamber,
at least one duct extending through said thermal insulation means from said blowing means to said charcoal chamber, and
heating means arranged in said at least one duct.

2. A chimney starter according to claim 1, further comprising grate means arranged inside said tubular housing between said upper opening of said tubular housing and said thermal insulation means.

3. A chimney starter according to claim 2, wherein one or more vent holes are formed through said tubular housing between said grate means and said thermal insulation means.

4. A chimney starter according to claim 1, wherein said tubular housing extends past said thermal insulation means to form a blower housing substantially enclosing said blowing means.

5. A chimney starter according to claim 1, wherein said thermal insulation means is arranged inside said tubular housing.

6. A chimney starter according to claim 1, wherein said blowing means is arranged to establish an air flow through said at least one duct, past said heating means and into said charcoal chamber.

7. A chimney starter according to claim 1, wherein said thermal insulation means comprises mineral wool.

8. A chimney starter according to claim 1, wherein said chimney starter further comprises a timer arranged to turn off said blowing means and/or said heating means.

9. A chimney starter according to claim 1, wherein said heating means is electrical heating means having a power of between 200 W and 4000 W.

10. A chimney starter according to claim 1, wherein said blowing means is centrally arranged in relation to said tubular housing.

11. A chimney starter according to claim 1, wherein said at least one duct including said heating means is centrally arranged in relation to said tubular housing.

12. A chimney starter according to claim 1, wherein said a tubular housing is formed separate from said blowing means and said heating means.

13. A chimney starter according to claim 1, wherein said thermal insulation means has a thickness between 8 mm and 300 mm in a longitudinal direction of said tubular housing.

14. An ignite unit for igniting solid fuel arranged in a tubular housing placed on top of said ignite unit, said ignite unit comprising
a top surface comprising a support surface for holding a tubular housing being placed on said top surface,
thermal insulation means arranged beneath at least a part of said top surface,
blowing means arranged beneath said thermal insulation means,
at least one duct extending through said thermal insulation means from said blowing means to or through said top surface, and
heating means arranged in said at least one duct.
